(19) United States
(12) Patent Application Publication
(10) Pub. No.: US 2025/0256977 A1
(43) Pub. Date: Aug. 14, 2025

(54) SURFACE-TREATED CALCIUM CARBONATE AND RESIN COMPOSITION USING SAME

(71) Applicant: MARUO CALCIUM CO., LTD., Hyogo (JP)

(72) Inventors: Shuji MIKI, Hyogo (JP); Yuki MIYAI, Hyogo (JP); Tomonori KOSAKA, Hyogo (JP); Homare KUDO, Hyogo (JP); Shigeo TAKIYAMA, Hyogo (JP)

(21) Appl. No.: 18/711,177

(22) PCT Filed: Aug. 29, 2023
(86) PCT No.: PCT/JP2023/031270

§ 371 Date: May 17, 2024

(30) Foreign Application Priority Data
Oct. 28, 2022 (JP) 2022-173549

(51) Int. Cl. C01F 11/18; C09C 1/02; C09C 3/08; C09D 7/62; C09J 11/06; C09J 201/00

(52) U.S. Cl. CPC C01F 11/18; C09C 1/021; C09C 3/08; C09D 7/62; C09J 11/06; C09J 201/00; C01P 2006/12; C01P 2006/17

(57) ABSTRACT

Surface-treated calcium carbonate of the present invention contains calcium carbonate subjected to surface treatment with a fatty acid-based surface treatment agent, and satisfies a certain BET specific surface area (Sw), certain loss on heat per unit area (As), a certain lightness maintenance ratio (%), a certain average pore diameter at which an increase in a mercury intrusion amount reaches a maximum value in a certain pore distribution in a mercury intrusion method (Dxp), and a certain average pore diameter amount (maximum value of increase in mercury intrusion amount (Dyp)/average pore diameter (Dxp)).

### TECHNICAL FIELD

The present invention relates to surface-treated calcium carbonate, and a resin composition using the same.

### BACKGROUND ART

Calcium carbonate is often used as an extender pigment for sealants, adhesives, paints, plastisols, and the like. Meanwhile, the prices of organic thickeners and silica are increasing dramatically along with uncertainty of supply of imported materials and an increase in cost of imported materials in recent years. Thus, calcium carbonate, which can be obtained by using Japanese limestone as a raw material, gains increasing attention, and colloidal calcium carbonate that is fine and is highly dispersed is desired for the purpose of imparting high viscosity and thixotropy.

In addition, regarding, for example, sealing materials and the like to be used for houses, products that have a super long-term assurance effective for a long period of time such as 30 years or 50 years rather than a conventional 10-year assurance have been increasing in number, and thus resin compositions to be used in such products are required to have not only favorable storage stability but also super long-term durability after application and curing. Also, paints and the like to be used for outdoor buildings are required to have higher durability so as to be resistant to high temperatures and solar irradiation during days in summer in recent years on which the maximum temperature exceeds 35° C.

To meet such needs, for example, Patent Document 1 discloses surface-treated calcium carbonate constituted by fine and highly dispersed colloidal calcium carbonate capable of imparting high viscosity and thixotropy to a resin composition.

However, although the surface-treated calcium carbonate disclosed in Patent Document 1 is fine and has high dispersibility, a further improvement in thermal stability of the powder is desired. In addition, for a resin composition containing the surface-treated calcium carbonate, it is also desired to improve the storage stability of the resin composition itself and its super long-term durability after application.

### RELATED ART DOCUMENTS

### Patent Documents

Patent Document 1: Japanese Patent No. 3650391

### SUMMARY OF INVENTION

### Problem to be Solved by the Invention

The present invention was achieved in order to solve the aforementioned problems, and it is an object thereof to provide surface-treated calcium carbonate that has favorable fineness and dispersibility, has excellent thermal stability, and is capable of improving the storage stability of a resin blended therewith and the durability thereof after application, and a resin composition using the surface-treated calcium carbonate.

### Means for Solving the Problem

The present invention is a surface-treated calcium carbonate comprising calcium carbonate subjected to surface treatment with a fatty acid-based surface treatment agent,
wherein the fatty acid-based surface treatment agent is at least one compound selected from the group consisting of fatty acids and fatty acid salts, and
relational expressions (a) to (f) below are satisfied:
(a) 20≤Sw≤100 (m²/g)
(b) 1.0≤As≤7.5 (mg/m²)
(c) LC≥55 (%)
(d) 0.003≤Dxp≤0.03 (μm)
(e) 50≤Dyp/Dxp≤180
(f) 0.03≤Is≤2.57 (μmol/m²)
   where
Sw is a BET specific surface area (m²/g) that is determined through a nitrogen adsorption method,

As is loss on heat per unit surface area (mg/m²) that is determined using the following formula:

$$As = ( loss on heat per 1 g of the surface - treated calcium carbonate ( mg / g ) between 200 ° C . and 500 ° C . ) / Sw ( {m}^{2} / g ) ,$$

LC is a lightness maintenance ratio (%) that is determined using the following formula:

$$LC = ( an L value of a paste obtained by mixing the surface - treated calcium carbonate heated at 160 ° C . for 12 hours and diisononyl phthalate at a mass ratio of 1 to 2 ) / ( an L value of a paste obtained by mixing the calcium carbonate prior to heating and diisononyl phthalate at a mass ratio of 1 to 2 ) \times 100 ,$$

Dxp is an average pore diameter (μm) at which an increase in a mercury intrusion amount (cumulative value of increases in pore volume/log (average pore diameter)) reaches a maximum value (Dyp) in a pore distribution within a pore range of 0.001 to 0.1 μm in a mercury intrusion method, Dyp is the maximum value of an increase in the mercury intrusion amount (mL/g),

Dyp/Dxp is an average pore diameter amount, and

Is is an alkali metal content per unit specific surface area (umol/m²) that is calculated using the following formula:

$$Is = ( an alkali metal content per 1 g of the surface - treated calcium carbonate ( μmol / g ) ) / \{ Sw ( {m}^{2} / g ) \} .$$

In one embodiment, the calcium carbonate subjected to surface treatment with a fatty acid-based surface treatment agent satisfies formulae (g) and (h) below:

$$0.005 \leq Dxp \leq 0.025 ( μm ) , and \qquad ( g )$$

$$60 \leq Dyp / Dxp \leq 150. \qquad ( h )$$

The present invention is also a resin composition comprising the above surface-treated calcium carbonate and a resin.

In one embodiment, the resin is a sealant resin.

In one embodiment, the resin is an adhesive resin.

In one embodiment, the resin is a paint resin.

In one embodiment, the resin is a plastisol resin.

### Effects of the Invention

With the present invention, surface-treated calcium carbonate that is fine, has high dispersibility, and has excellent thermal stability can be efficiently obtained. When blended into a resin composition, the surface-treated calcium carbonate of the present invention can provide high viscosity and thixotropy and can also improve the storage stability. Furthermore, after being applied as, for example, a sealant, the resin composition can exhibit durability and weather resistance for a super long period of time.

### DESCRIPTION OF EMBODIMENTS

### Surface-Treated Calcium Carbonate

The surface-treated calcium carbonate of the present invention satisfies the following relational expressions (a), (b), (c), (d), (e), and (f):

$$20 \leq S w \underline{<} 100 ( {m}^{2} / g ) \qquad ( a )$$

$$1. \leq As \leq 7.5 ( mg / {m}^{2} ) \qquad ( b )$$

$$LC \geq 55 ( \% ) \qquad ( c )$$

$$0.003 \leq Dxp \leq 0.03 ( μm ) \qquad ( d )$$

$$50 \leq Dyp / Dxp \underline{<} 180 \qquad ( e )$$

$$0.03 \leq Is \leq 2.57 ( μmol / {m}^{2} ) . \qquad ( f )$$

### (a) BET Specific Surface Area Determined Through Nitrogen Adsorption Method; Sw

In the relational expression (a), Sw is the BET specific surface area of surface-treated calcium carbonate determined through a nitrogen adsorption method. Sw is 20 m²/g to 100 m²/g, preferably 30 m²/g to 60 m²/g, and more preferably 30 m²/g to 50 m²/g. If Sw is smaller than 20 m²/g, it is difficult to obtain a resin composition with high viscosity using the obtained surface-treated calcium carbonate. If Sw exceeds 100 m²/g, the dispersibility and the temporal dispersion stability of the obtained surface-treated calcium carbonate will decrease. Sw as described above can be measured using a method described later in the section of Examples.

Sw can be controlled by varying the various conditions for production of the surface-treated calcium carbonate of the present invention. Examples of the conditions under which Sw can be controlled to be within the range above include the concentration of lime milk used in carbonation reaction as described later, the temperature employed for the carbonation reaction, the concentration of carbon dioxide used, and the type of additive used in the carbonation reaction, as well as combinations thereof. If these conditions are insufficiently satisfied, it may be difficult to obtain surface-treated calcium carbonate with Sw within the range above.

### (b) Loss on Heat Per Unit Surface Area; as

In the relational expression (b), As is the loss on heat per unit surface area (mg/m²) and is determined using the following formula.

$$As = ( loss on heat per 1 g of the surface - treated calcium carbonate ( mg / g ) between 200 ° C . and 500 ° C . ) / Sw$$

In the present invention, As is 1.0 mg/m² to 7.5 mg/m², preferably 1.5 mg/m² to 5.0 mg/m², and more preferably 2.0 mg/m² to 4.0 mg/m². Note that As corresponds to the amount of a fatty acid-based surface treatment agent per unit surface area of surface-treated calcium carbonate (mg/m²). Some types of commercially available calcium carbonate satisfy the relational expression (a) above and are constituted by fine primary particles. However, in such calcium carbonate, the primary particles of such calcium carbonate coagulate into secondary particles, and the secondary particles further coagulate into tertiary particles, and accordingly, even an amount of a surface treatment agent that covers the calcium carbonate (loss on heat) that is smaller than 1.0 mg/m² is sufficient.

The surface-treated calcium carbonate of the present invention is fine and is highly dispersed, includes few tertiary particles, and has a high content of secondary particles dispersed. Accordingly, if the amount of a surface treatment agent that covers the calcium carbonate (loss on heat) is smaller than 1.0 mg/m², it is difficult to sufficiently cover the surface of the calcium carbonate with the surface treatment agent. Furthermore, if drying and powderization are performed despite insufficient treatment, untreated surfaces will attach to each other, resulting in formation of tertiary particles, and therefore, the effects of imparting high viscosity and high thixotropy, which are the object of the present invention, will not be obtained. On the other hand, if the amount of a surface treatment agent that covers the calcium carbonate (loss on heat) exceeds 7.5 mg/m², the storage stability of the surface-treated calcium carbonate will decrease due to an excess of the surface treatment agent, and when the surface-treated calcium carbonate is blended into a resin composition, the surface treatment agent will separate from the resin component and a plasticizer component, which will cause a decrease in physical properties. The loss on heat per unit specific surface area (As) as described above can be determined using a method described later in the section of Examples.

As can be controlled by varying the various conditions for production of the surface-treated calcium carbonate of the present invention. Examples of the conditions under which As can be controlled to be within the range above include the amount of usage of the surface treatment agent as described later, and the temperature employed for the surface treatment, as well as combinations thereof. If these conditions are insufficiently satisfied, it may be difficult to obtain surface-treated calcium carbonate with As within the range above.

### (c) Lightness Maintenance Ratio; LC

In the relational expression (c), LC is the lightness (L value) maintenance ratio (%) and is determined using the following formula.

$$LC = ( L value of paste obtained by mixing surface - treated calcium carbonate heated at 160 ° C . for 12 hours and diisononyl phthalate at mass ratio of 1 to 2 ) \text{} / ( L value of paste obtained by mixing surface - treated calcium carbonate prior to heating and diisononyl - phthalate at mass ratio of 1 to 2 ) \times 100 \qquad ( c1 )$$

In the present invention, LC is 55% or more, preferably 58% or more, and more preferably 60% or more. LC can serve as an index of the thermal resistance of the obtained surface-treated calcium carbonate. If the LC is less than 55%, the obtained surface-treated calcium carbonate powder will have low thermal resistance, leading to variation in the physical properties caused by thermal degradation during drying, and a decrease in the storage stability, in the production process of the surface-treated calcium carbonate. In addition, blending such surface-treated calcium carbonate into a sealant, an adhesive, a paint, or a plastisol will lead to a decrease in the storage stability and deterioration of the thermal resistance and the weather resistance after application.

The lightness (L value) maintenance ratio (LC) can be measured using a method described later in the section of Examples.

LC can be controlled by varying the various conditions for production of the surface-treated calcium carbonate of the present invention. Examples of the conditions under which LC can be controlled to be within the range above include the amount of usage of the surface treatment agent as described later, the temperature employed for the surface treatment, and the type and amount of additive used in the carbonation reaction, as well as combinations thereof. If these conditions are insufficiently satisfied, it may be difficult to obtain surface-treated calcium carbonate with LC within the range above.

### (d) Average Pore Diameter at Which Increase in Mercury Intrusion Amount Reaches Maximum Value; Dxp

In the relational expression (d), Dxp is an average pore diameter (μm) at which an increase in the mercury intrusion amount (cumulative value of increases in pore volume/log (average pore diameter)) reaches the maximum value (Dyp) in the pore distribution within a pore range of 0.001 μm to 0.1 μm, the pore range being measured using a mercury intrusion method (porosimeter). Dxp means the fineness of gaps between the surface-treated calcium carbonate particles, and serves as an index of the dispersion state of the surface-treated calcium carbonate.

In the present invention, Dxp represents the average diameter of gaps between primary particles rather than the fineness of the particles represented by the BET specific surface area (m²/g) determined by the nitrogen adsorption method in the relational expression (a) above. Dxp is 0.003 μm to 0.03 μm, preferably 0.005 μm to 0.025 μm, and more preferably 0.006 μm to 0.020 μm. If Dxp is less than 0.003 μm, the obtained surface calcium carbonate may lack temporal stability due to primary particles or secondary particles being too fine. If Dxp exceeds 0.03 μm, it is difficult to obtain a resin composition with high viscosity using the obtained surface-treated calcium carbonate due to primary particles being too large, or many secondary particles being formed through strong coagulation of primary particles.

Here, “the increase in the mercury intrusion amount” means an increase in the pore volume and is calculated using a formula “(cumulative value of increases in pore volume/log (average pore diameter))”, and the unit thereof is mL/g. The smaller the pore diameter is, the smaller the pore volume is, and therefore, the maximum increase in the mercury intrusion amount (Dyp) depends on the average pore diameter (Dxp).

Dxp can be controlled by varying the various conditions for production of the surface-treated calcium carbonate of the present invention. Examples of the conditions under which Dxp can be controlled to be within the range above include: the concentration of lime milk used in carbonation reaction as described later, the temperature employed for the carbonation reaction, the concentration of carbon dioxide used, and the type of additive used in the carbonation reaction; the concentration of calcium carbonate employed in aging, the aging temperature, and the aging time; and the amount of usage of the surface treatment agent; as well as combinations thereof. If these conditions are insufficiently satisfied, it may be difficult to obtain surface-treated calcium carbonate with Dxp within the range above.

### (e) Dyp/Dxp

In the relational expression (e), Dyp/Dxp represents the number of pores having the average pore diameter in the expression (d), and serves as an index of high viscosity, which is the object of the present invention. As mentioned above, the smaller the pore diameter is, the smaller the pore volume is, and therefore, the number of pores having the average pore diameter can be derived using the maximum increase in mercury intrusion amount (Dyp), and the average pore diameter (Dxp) obtained from the relational expression (d). The larger the numerical value of Dyp/Dxp is, the higher the viscosity of a resin composition blended with the obtained surface-treated calcium carbonate. Dyp/Dxp also serves as an index of the dispersion state of the surface-treated calcium carbonate.

In the present invention, Dyp/Dxp is 50 to 180, preferably 60 to 150, and more preferably 70 to 130. If Dyp/Dxp is smaller than 50, it is difficult to obtain a resin composition with high viscosity using the obtained surface-treated calcium carbonate. If the Dyp/Dxp exceeds 180, primary particles or secondary particles may lack temporal stability due to the average pore diameter being excessively small.

Note that, if the obtained surface-treated calcium carbonate is out of the range of the relational expression (d) or (e) above, for example, a paint composition blended with such calcium carbonate may have low thixotropy, and a sealant composition blended with such calcium carbonate may have decreased strength.

The mercury intrusion (porosimeter) measurement used to determine whether or not the ranges of the relational expressions (d) and (e) are satisfied can be performed according to a method described later in the section of Examples.

Dyp/Dxp can be controlled by varying the various conditions for production of the surface-treated calcium carbonate of the present invention. Examples of the conditions under which Dyp/Dxp can be controlled to be within the range above include the concentration of calcium carbonate employed for aging as described later, the aging temperature, and the aging time, as well as combinations thereof. If these conditions are insufficiently satisfied, it may be difficult to obtain surface-treated calcium carbonate with Dyp/Dxp within the range above.

### (f) Alkali Metal Content per Unit Specific Surface Area; Is

In the relational expression (f), Is is the alkali metal content per unit specific surface area (μmol/m²) calculated using the formula (f1) below.

$$Is = ( alkali metal content per 1 g of surface - treated calcium carbonate ( μmol / g ) / \{ Sw ( {m}^{2} / g ) \} \qquad ( f1 )$$

In the present invention, Is is 0.03 μmol/m² to 2.57 μmol/m², preferably 0.15 μmol/m² to 2.2 μmol/m², and more preferably 0.3 μmol/m² to 2.0 μmol/m². If Is is less than 0.03 μmol/m², the surface treatment state of the obtained surface-treated calcium carbonate tends to be poor. Accordingly, when the surface-treated calcium carbonate is blended into a resin composition, sufficiently high viscosity is not imparted in some cases due to a decrease in the dispersibility of the surface-treated calcium carbonate. Meanwhile, among alkali metal compounds, for example, sodium compounds are known to have high exothermic reactivity and easily react with moisture outside the system. Therefore, if the obtained surface-treated calcium carbonate contains a sodium compound as an alkali metal compound and Is exceeds 2.57 mol/m² in this case, the storage stability of, for example, a sealing material in which the surface-treated calcium carbonate is used may decrease.

Here, the “alkali metal content per 1 g of surface-treated calcium carbonate (μmol/g)” used to calculate Is using the formula (f1) above can be measured using, for example, a method described later in the section of Examples.

Is can be controlled by monitoring, as appropriate, the alkali metal content in raw materials, a surface treatment agent, and/or additives used to produce the surface-treated calcium carbonate of the present invention and adjusting the amount of usage thereof. Is can be controlled by, for example, adjusting the amount of usage of the surface treatment agent in accordance with the specific surface area of calcium carbonate before surface treatment. If this amount of usage is insufficiently adjusted, it may be difficult to obtain surface-treated calcium carbonate with Is within the range above.

Calcium Carbonate Subjected to Surface Treatment with Fatty Acid-Based Surface Treatment Agent

The surface-treated calcium carbonate of the present invention that satisfies the relational expressions (a), (b), (c), (d), (e), and (f) above is constituted by calcium carbonate subjected to surface treatment with a fatty acid-based surface treatment agent, which is one type of organic acid-based surface treatment agents. That is to say, the surface-treated calcium of the present invention is in the form of a composition containing calcium carbonate as a main component.

A production method for the surface-treated calcium carbonate of the present invention is not particularly limited as long as the surface-treated calcium carbonate is fine and has high dispersibility and excellent thermal resistance.

The following is a specific description of an example of a preferable production method for the surface-treated calcium carbonate of the present invention.

### (1) Carbonation Reaction

First, calcium carbonate before surface treatment can be obtained by adding additives (e.g., a complex-forming agent for promoting formation of a complex with a calcium component, and an inorganic acid and/or a salt thereof) to lime milk, introducing carbon dioxide to the lime milk, performing carbonation reaction to produce a calcium carbonate slurry, and then aging the slurry, for example, according to a conventional method as described in JP H10-72215A, but there is no particular limitation to this procedure.

Examples of the complex-forming agent include: hydroxycarboxylic acids such as citric acid, oxalic acid, and malic acid, alkali metal salts thereof, alkaline earth metal salts thereof, and ammonium salts thereof, polyhydroxycarboxylic acids such as gluconic acid and tartaric acid, alkali metal salts thereof, alkaline earth metal salts thereof, and ammonium salts thereof, aminopolycarbons such as iminodiacetic acid, ethylenediaminetetraacetic acid, and nitrilotriacetic acid, alkali metal salts thereof, alkaline earth metal salts thereof, and ammonium salts thereof; polyacetic acids such as hexametaphosphoric acid and tripolyphosphoric acid, alkali metal salts thereof, alkaline earth metal salts thereof, and ammonium salts thereof, and ketones such as acetylacetone, methyl acetoacetate, and allyl acetoacetate; as well as combinations thereof, but are not particularly limited thereto.

Examples of the inorganic acid and/or a salt thereof include: mineral acids such as sulfuric acid (e.g., concentrated sulfuric acid), hydrochloric acid (e.g., concentrated hydrochloric acid), nitric acid (e.g., concentrated nitric acid), phosphoric acid, boric acid, and hydrofluoric acid, alkali metal salts thereof, alkaline earth metal salts thereof, and ammonium salts thereof, as well as combinations thereof, but are not particularly limited thereto. It is preferable to use: sulfuric acid (e.g., concentrated sulfuric acid), nitric acid (e.g., concentrated nitric acid), phosphoric acid, alkali metal salts thereof, alkaline earth metal salts thereof, and ammonium salts thereof, as well as combinations thereof, because safety against toxicity, irritant odor, and the like can be ensured, and these substances can be easily used for industrial purposes.

### (1-1) Conditions of Carbonation Reaction

It is preferable to prepare lime milk used in the carbonation reaction such that the concentration thereof is 3.5 mass % to 10.2 mass %. Note that the concentration of lime milk can be varied depending on the type of additive used together.

For example, when a complex-forming agent is used as an additive, it is more preferable to prepare the lime milk such that the concentration thereof is 6.0 mass % to 8.0 mass %. When an inorganic acid and/or a salt thereof is used as an additive, it is preferable to prepare the lime milk such that the concentration thereof is 4.0 mass % to 7.0 mass %, and more preferably 4.0 mass % to 6.0 mass %. When an inorganic acid and a salt thereof are used together, dispersed calcium carbonate can be obtained immediately after the start of the carbonation reaction. Accordingly, there is an advantage in that time required for aging, which will be described later, can be shortened, and undesired particle growth can be suppressed.

If the concentration of lime milk used in the carbonation reaction is less than 3.5 mass %, it is not possible to expect that calcium carbonate with further improved dispersibility is obtained, and the cost may increase contrarily. If the concentration of lime milk used in the carbonation reaction exceeds 10.2 mass %, primary particles are likely to coagulate after the carbonation reaction, and thus it may be difficult to obtain calcium carbonate with improved dispersibility despite of aging.

The addition amount of the additive may be selected as appropriate by a person skilled in the art depending on the type of additive used.

For example, when a complex-forming agent is used as an additive, the amount of the complex-forming agent added to the lime milk as an additive preferably corresponds to 0.5 mass % to 2.0 mass % based on the total amount of a reaction product after the addition of the complex-forming agent to the lime milk. Here, if the addition amount of the complex-forming agent used as an additive is less than 0.5 mass %, it may be difficult to obtain surface-treated calcium carbonate that is fine and is highly dispersed. If the addition amount of the complex-forming agent used as an additive exceeds 2.0 mass %, the obtained surface-treated calcium carbonate may have insufficient thermal resistance.

When an inorganic acid and/or a salt thereof is used as an additive, the amount of the inorganic acid and/or the salt thereof added to the lime milk as an additive preferably corresponds to 0.3 mass % to 9.0 mass % based on the total amount of a reaction product after the addition of the inorganic acid and/or the salt thereof to the lime milk. Here, if the addition amount of the inorganic acid and/or the salt thereof used as an additive is less than 0.3 mass %, it may be difficult to obtain surface-treated calcium carbonate that is fine and is highly dispersed. If the addition amount of the inorganic acid and/or the salt thereof used as an additive exceeds 9.0 mass %, there is very little change in the fineness of the obtained surface-treated calcium carbonate, and the productivity may decrease contrarily.

A temperature that can be employed for the carbonation reaction is, for example, 5° C. to 30° C. For example, when an inorganic acid and/or a salt thereof is used as an additive, the temperature is preferably 5° C. to 20° C., more preferably 5° C. to 15° C., and even more preferably 5° C. to 12° C. for the reason that the BET specific surface area immediately after the carbonation can be increased, even finer calcium carbonate is thus obtained, and a subsequent aging process for dispersion can be performed more efficiently.

Carbon dioxide that can be employed for the carbonation reaction may be mixed with air, and it is preferable that the concentration of carbon dioxide is set to 10 vol % to 50 vol % with respect to the total amount of mixed gas of carbon dioxide and air. If the concentration of carbon dioxide is less than 10 vol %, primary particles of calcium carbonate obtained after the reaction may grow to an undesired size. If the concentration of carbon dioxide exceeds 50 vol %, the cost may increase from the industrial viewpoint, and the productivity may decrease. Furthermore, the flow rate of carbon dioxide that can be employed for the carbonation reaction is, for example, 300 L/hour to 3000 L/hour per 1 kg of calcium hydroxide in terms of the flow rate of the mixed gas of carbon dioxide and air. If the flow rate is less than 300 L/hour, primary particles of calcium carbonate obtained after the reaction may grow to an undesired size. If the flow rate exceeds 3000 L/hour, the cost may increase from the industrial viewpoint, and the productivity may decrease.

### (1-2) Conditions of Aging

Calcium carbonate is prepared such that the concentration thereof that can be employed for aging is preferably 2.4 mass % to 13.0 mass %, more preferably 4.0 mass % to 11.0 mass %, and even more preferably 5.0 mass % to 9.0 mass %, based on the total amount of the calcium carbonate slurry irrespective of the type of additive used. If the concentration of calcium carbonate is less than 2.4 mass %, the productivity may decrease from the industrial viewpoint. If the concentration of calcium carbonate exceeds 13.0 mass %, it may be difficult to uniformly stir the system in the case where the structural viscosity in the system increases as a result of an improvement in the dispersibility through aging. The concentration of calcium carbonate employed for aging is important to an improvement in the dispersibility of the obtained surface-treated calcium carbonate. For example, when minute particles of calcium carbonate are used, it is preferable to employ a concentration that is as low as possible within the concentration range above in order to improve the dispersibility.

A temperature that can be employed for the aging is, for example, 30° C. to 70° C. For example, when an inorganic acid and/or a salt thereof is used as an additive, the temperature is preferably 25° C. to 45° C., more preferably 25° C. to 40° C., and even more preferably 25° C. to 35° C. for the reason that high-temperature aging promotes the growth of particles, and the aging effect is insufficiently exhibited at an excessively low temperature.

Time that can be employed for the aging can be time required to satisfy the ranges of the relational expressions (d) and (e) above serving as the indices of the dispersibility. When blended into a resin composition, the thus obtained surface-treated calcium carbonate can provide high viscosity. The time for the aging is not particularly limited because it can be varied depending on the conditions above, but it is preferably 24 hours to 120 hours. For example, when an inorganic acid and/or a salt thereof is used as an additive, it can be more preferable to select 30 hours to 100 hours, and it can be even more preferable to select 30 hours to 50 hours, in order to suppress excessive growth of calcium carbonate particles caused by the aging. If the time for the aging is shorter than 24 hours, it may be difficult to obtain surface-treated calcium carbonate with favorable dispersibility. If the time for the aging exceeds 120 hours, the cost may increase from the industrial viewpoint.

### (2) Surface Treatment

Subsequently, the calcium carbonate is subjected to surface treatment with a fatty acid-based surface treatment agent.

The fatty acid-based surface treatment agent is not particularly limited as long as a fatty acid and/or a fatty acid salt that can be used for surface treatment of calcium carbonate particles in the art is used, and various fatty acid-based surface treatment agents can be used.

The fatty acid-based surface treatment agent is, for example, a higher fatty acid, preferably a C6 to C31 fatty acid (i.e., a fatty acid with 6 to 31 carbon atoms), and more preferably a C9 to C21 fatty acid (i.e., a fatty acid with 9 to 21 carbon atoms). Alternatively, the fatty acid-based surface treatment agent may be, for example, a modified or unmodified fatty acid derived from an animal or plant.

Examples of a fatty acid contained in such a fatty acid-based surface treatment agent include fatty acids such as saturated fatty acids, unsaturated fatty acids, and mixtures of saturated fatty acids and unsaturated fatty acids (e.g., caproic acid, caprylic acid, pelargonic acid, capric acid, undecanoic acid, lauric acid, myristic acid, palmitic acid, stearic acid, arachic acid, behenic acid, 2-ethylbutyric acid, 2-ethylhexanoic acid, isononanoic acid, isodecanoic acid, neodecanoic acid, isotridecanoic acid, isopalmitic acid, isostearic acid, myristoleic acid, palmitoleic acid, oleic acid, linoleic acid, linolenic acid, beef tallow stearic acid, palm kernel fatty acids, coconut fatty acids, palm fatty acids, palm stearic acid, beef tallow fatty acids, soybean fatty acids, partially hydrogenated palm kernel fatty acids, partially hydrogenated coconut fatty acids, partially hydrogenated beef tallow fatty acids, partially hydrogenated soybean fatty acids, fully hydrogenated palm kernel fatty acids, fully hydrogenated coconut fatty acids, fully hydrogenated beef tallow fatty acids, and fully hydrogenated soybean fatty acids), as well as combinations thereof and salts thereof. Examples of the fatty acid salt contained in the fatty acid-based surface treatment agent include alkaline metal salts of the fatty acids above (e.g., sodium salts and potassium salts), alkaline earth metal salts of the fatty acids above (e.g., calcium salts and magnesium salts), ammonium salts of the fatty acids above, and amine salts of the fatty acids above, as well as combinations thereof. From the viewpoint of cost and supply stability, it is preferable to use, as the fatty acid-based surface treatment agent, saturated fatty acids and unsaturated fatty acids (e.g., lauric acid, myristic acid, palmitic acid, stearic acid, oleic acid, beef tallow stearic acid, palm kernel fatty acids, partially hydrogenated palm fatty acids, fully hydrogenated palm fatty acids, coconut fatty acids, partially hydrogenated coconut fatty acids, fully hydrogenated coconut fatty acids, palm fatty acids, palm stearic acid, beef tallow fatty acids, partially hydrogenated beef tallow fatty acids, fully hydrogenated beef tallow fatty acids, soybean fatty acids, partially hydrogenated soybean fatty acids, and fully hydrogenated soybean fatty acids), as well as combinations thereof and salts thereof.

Note that, in the present invention, other surface treatment agents may be used together with the above-mentioned fatty acid-based surface treatment agent as long as the obtained surface-treated calcium carbonate satisfies the ranges of the relational expressions (a) to (f) above. Examples of the other surface treatment agents include sulfonic acids such as alkylbenzenesulfonic acids and salts thereof, fatty acid esters such as stearyl stearate, resin acids such as abietic acid and salts thereof, and metal soaps such as calcium soaps, as well as combinations thereof.

The surface treatment level (the amount of usage of the fatty acid-based surface treatment agent) depends on the specific surface area of the calcium carbonate dough, and thus is not particularly limited as long as the range of the relational expression (b) above is satisfied. However, the surface treatment level is preferably 3.5 mass % to 50 mass %, more preferably 5 mass % to 40 mass %, and even more preferably 7 mass % to 30 mass %, based on the total amount of the calcium carbonate solid in the calcium carbonate slurry before the treatment. If the surface treatment level is less than 3.5 mass %, it may be difficult to obtain surface-treated calcium carbonate that is fine and has high dispersibility. In addition, if drying and powderization are performed despite such a surface treatment level, the obtained surface-treated calcium carbonate is likely to coagulate via untreated surfaces. Accordingly, when blended into a resin composition, the obtained surface-treated calcium carbonate may have difficulty in providing high viscosity and high thixotropy. If the surface treatment level exceeds 30 mass %, the storage stability of the obtained surface-treated calcium carbonate will decrease due to an excess of the surface treatment agent, and when the surface-treated calcium carbonate is blended into a resin composition, the treatment agent will separate from the surface-treated calcium carbonate and get mixed in the resin component and a plasticizer component, which will cause a decrease in physical properties.

Although the surface treatment method is not particularly limited, it is preferable to perform the surface treatment under wet conditions in order to improve the surface treatment state. When the surface treatment is performed in an aqueous slurry, it is preferable to perform the surface treatment at a temperature higher than the melting points of the fatty acid and the fatty acid salt used as the surface treatment agent, and the surface treatment temperature in such a case is preferably 20° C. to 98° C., more preferably 40° C. to 90° C., and even more preferably 60° C. to 80° C. If the surface treatment temperature is lower than 20° C., adsorption-binding of the fatty acid-based surface treatment agent to calcium carbonate, which will be described later, is unlikely to occur, which may result in ununiform surface treatment. If the treatment temperature exceeds 98° C., there is a risk of bumping, and a pressure-resistant apparatus may be required separately.

After the fatty acid-based surface treatment agent is added to calcium carbonate, it is preferable to stir the mixture for a predetermined period of time for the purpose of more uniform surface treatment.

In one embodiment, the stirring time is, for example, 30 minutes to 24 hours. Here, for example, when a complex-forming agent is used as an additive, the stirring time is preferably set to 6 hours to 24 hours, and more preferably 12 hours to 24 hours, in order to prevent or suppress impairment of the thermal resistance of the obtained surface-treated calcium carbonate due to the complex-forming agent inhibiting adsorption or binding of the fatty acid-based surface treatment agent to calcium carbonate.

Alternatively, the stirring time may be selected as appropriate by a person skilled in the art depending on the type of additive used. For example, when a complex-forming agent is used as an additive, it can be preferable to select 6 hours to 24 hours, and it can be more preferable to select 12 hours to 24 hours. When the stirring time is shorter than 6 hours, favorable surface treatment state will not be obtained due to an effect of the complex-forming agent to inhibit the adsorption-binding of the fatty acid-based surface treatment agent to calcium carbonate, which may result in ununiform surface treatment and insufficient thermal resistance of the obtained surface-treated calcium carbonate. If the stirring time exceeds 24 hours, it will take long time to produce the surface-treated calcium carbonate, which may result in a decrease in the production efficiency and an increase in the cost.

After the above-mentioned surface treatment, the obtained particles may be powderized through any operations such as dehydration, drying, and pulverization, for example, according to ordinary methods.

In this manner, surface-treated calcium carbonate that contains calcium carbonate subjected to surface treatment with a fatty acid-based surface treatment agent and satisfies the relational expressions (a) to (f) above can be obtained.

### Resin Composition

The above-mentioned surface-treated calcium carbonate is useful as a constituent material for resin compositions such as a sealing material, an adhesive, a paint, and a plastisol.

The sealing material contains the surface-treated calcium carbonate of the present invention and a sealant resin. Examples of the sealant resin include a polyurethane resin, a polysulfide resin, a silicone resin, a modified silicone resin, a polyisobutylene resin, an epoxy resin, and a polyester resin as well as combinations thereof, but are not particularly limited thereto.

In the present invention, the blend ratio between the surface-treated calcium carbonate and the sealant resin is not particularly limited, and can be determined by a person skilled in the art as appropriate in accordance with desired physical properties. In one embodiment, the content of the surface-treated calcium carbonate of the present invention is 1 part by mass to 100 parts by mass with respect to 100 parts by mass of the sealant resin contained in the sealant. Various additives such as a colorant and a stabilizer may be added to the sealant if necessary.

The adhesive contains the surface-treated calcium carbonate of the present invention and an adhesive resin. Examples of the adhesive resin include a urea resin, a phenol resin, an epoxy resin, a silicone resin, an acrylic resin, a polyurethane resin, and a polyester resin, as well as combinations thereof, but are not particularly limited thereto.

In the present invention, the blend ratio between the surface-treated calcium carbonate and the adhesive resin is not particularly limited, and can be determined by a person skilled in the art as appropriate in accordance with desired physical properties. In one embodiment, the content of the surface-treated calcium carbonate of the present invention is 1 part by mass to 100 parts by mass with respect to 100 parts by mass of the adhesive resin contained in the adhesive. Various additives such as a stabilizer and a plasticizer may be added to the adhesive if necessary.

The paint contains the surface-treated calcium carbonate of the present invention and a paint resin. Examples of the paint resin include: resins for a solvent-based paint such as an alkyd resin, an acrylic resin, a vinyl acetate resin, a urethane resin, a silicone resin, a fluororesin, a styrene resin, a melamine resin, and an epoxy resin; emulsion resins for a general paint such as an alkyd resin, an acrylic resin, a latex resin, a vinyl acetate resin, a urethane resin, a silicone resin, a fluororesin, a styrene resin, a melamine resin, and an epoxy resin; water-soluble resins for a general paint typified by an alkyd resin, an amine resin, a styrene-allyl alcohol resin, an aminoalkyd resin, a polybutadiene resin, and the like; dispersion resins for a paint obtained by blending an emulsion resin for a general paint and a water-soluble resin for a general paint; dispersion resins containing a crosslinked water-soluble resin as an emulsifier; and acrylic hydrosol; as well as combinations thereof, but are not particularly limited thereto.

In the present invention, the blend ratio between the surface-treated calcium carbonate of the present invention and the paint resin is not particularly limited, and can be determined by a person skilled in the art as appropriate in accordance with desired physical properties. In one embodiment, the content of the surface-treated calcium carbonate of the present invention is 1 part by mass to 100 parts by mass with respect to 100 parts by mass of the paint resin contained in the paint. Various additives such as a plasticizer and a dispersant may be added to the paint if necessary.

The plastisol contains the surface-treated calcium carbonate of the present invention and a plastisol resin. Examples of the plastisol resin include a vinyl chloride sol, an acrylic sol, a water-soluble acrylic sol, and a urethane sol, as well as combinations thereof, but are not particularly limited thereto.

In the present invention, the blend ratio between the surface-treated calcium carbonate and the plastisol resin is not particularly limited, and can be determined by a person skilled in the art as appropriate in accordance with desired physical properties. In one embodiment, the content of the surface-treated calcium carbonate of the present invention is 1 part by mass to 100 parts by mass with respect to 100 parts by mass of the plastisol resin contained in the plastisol. Various additives such as a stabilizer may be added to the plastisol if necessary.

In addition to the above-mentioned surface-treated calcium carbonate and the various resins, fillers such as colloidal calcium carbonate, heavy calcium carbonate, colloidal silica, talc, kaolin, zeolite, a resin balloon, and a glass balloon; plasticizers such as dioctyl phthalate and dibutyl phthalate; petroleum-based solvents such as toluene and xylene; solvents such as ketones (e.g., acetone and methyl ethyl ketone) and ether esters (e.g., cellosolve acetate); silicone oils, fatty acid ester-modified silicone oils; various additives; and colorants; as well as combinations thereof may be contained in the resin composition of the present invention as other components in order to adjust physical properties such as viscosity. The contents of the other components in the resin composition of the present invention are not particularly limited, and a person skilled in the art can select, as appropriate, suitable contents thereof within such ranges that the effects exhibited by the above-mentioned surface-treated calcium carbonate and various resins are not impaired.

When the resin composition of the present invention is a curable resin composition such as a sealant or an adhesive, a cured product having excellent viscosity, thixotropy, and storage stability, as well as high thermal stability can be provided. Also, when the resin composition of the present invention is, for example, a paint, even a small amount of the paint has excellent viscosity, thixotropy, anti-sagging properties, and storage stability. In addition, when the resin composition of the present invention is, for example, a resin composition for a plastisol, the resin composition has excellent viscosity and thixotropy, is capable of achieving a weight reduction due to a small amount of the resin composition being blended, and has high storage stability. Also, the thermal stability during baking and curing and after curing are excellent.

### EXAMPLES

Hereinafter, the present invention will be described in detail by way of examples, but the present invention is not limited to these examples. Note that, in the following descriptions, “%” means “mass %” and “part” means “part by mass” unless otherwise stated.

Measurement apparatuses used in examples and comparative examples were as follows.

(A) BET Specific Surface Area Determined through Nitrogen Adsorption Method (Sw)

A measurement glass cell filled with 200 mg of the surface-treated calcium carbonate sample obtained in each of the examples and the comparative examples was set in a BET specific surface area analyzer (Macsorb HM Model-1201, manufactured by Mountech Co., Ltd.). After the sample was pretreated at 200° C. for 10 minutes with nitrogen being introduced, and was then cooled for 4 minutes, the BET specific surface area was measured using a one-time measurement method.

(B) Loss on Heat per Unit Specific Surface Area (As)

A cylindrical sample pan (made of platinum) with a diameter of 5 mm and a depth of 5 mm filled with 20 mg of surface-treated calcium carbonate was set in a thermal analyzer (ThermoPlusEVO2, manufactured by Rigaku Corporation). The sample was heated from normal temperature to 510° C. at a heating rate of 15° C./minute, and the loss on heat between 200° C. and 500° C. was measured. Then, the “loss-on-heat ratio (mg/g) per 1 g of surface-treated calcium carbonate” was calculated. The loss on heat per unit specific surface area was calculated by dividing the loss-on-heat ratio by the BET specific surface area value (Sw).

(C) Lightness (L value) Maintenance Ratio (LC)

50 g of the obtained surface-treated calcium carbonate was filled into a crucible (made of a ceramic) and was heated in an electric furnace at 160° C. for 12 hours. 10 g of the surface-treated calcium carbonate before or after the heating and 20 g of diisononyl phthalate (DINP) were filled into a 100-mL PP (polypropylene) cup, and a planetary defoaming kneader (KK-1000W, manufactured by Kurabo Industries Ltd.) was used to subject the sample to defoaming under a kneading condition of 5-5-6. The powder on the cup wall surface was scraped off, and was then subjected to defoaming under a kneading condition of May 5, 2018. Thus, a paste was produced. Here, in the kneading condition “a-b-c” above, “a” represents a revolution condition, “b” represents a rotation condition, and “c” represents time (c×10 seconds).

Next, the paste obtained as described above was filled into a reflection measurement cell (with a diameter of 3 mm) for a color-difference meter (Color meter ZE 6000, manufactured by Nippon Denshoku Industries Co., Ltd.) to about 80% of the cell volume. The color differences, L, a, and b values, were measured through the reflection measurement, and the L value obtained through the color difference measurement was employed as the lightness. Then, the lightness maintenance ratio was calculated as a percentage (%) according to the formula (c1) below.

$$LC = ( L value of paste obtained by mixing surface - treated calcium carbonate heated at 160 ° C . for 12 hours and diisononyl phthalate at mass ratio of 1 to 2 ) \text{} / ( L value of paste obtained by mixing surface - treated calcium carbonate prior to heating and diisononyl - phthalate at mass ratio of 1 to 2 ) \times 100 \qquad ( c1 )$$

### (D) Average Pore Diameter at Which Increase in Mercury Intrusion Amount Reaches Maximum Value (Dxp)

About 0.10 g of the surface-treated calcium carbonate was filled into a measurement cell (with a cell constant of 10.79 ml/pF), and the average pore diameter (Dxp) at which an increase in the mercury intrusion amount reached the maximum value was measured using a mercury porosimeter pore distribution measurement apparatus (AutoPore IV, manufactured by Shimadzu Corporation). Here, the measurement conditions employed in this measurement were as follows: mercury was of 99.99% purity, the surface tension was 480 dyns/cm, and the contact angle was 135°.

### (E) Dyp/Dxp

Dyp/Dxp was calculated using the maximum value of an increase in the mercury intrusion amount (Dyp) measured in (D) above and the average pore diameter (μm) (Dxp).

### (F) Alkali Metal Content per Unit Specific Surface Area (Is)

First, 0.5 g of the surface-treated calcium carbonate obtained in each of the examples and the comparative examples was filled into a crucible (made of a ceramic) and was fired in an electric furnace at 300° C. for 3 hours. Subsequently, the sample was allowed to cool and was placed in a 200-mL beaker. 60 mL of distilled water and 7.5 mL of 61% nitric acid were added to the sample in this order, and the top of the beaker was covered with a watch glass. Then, the mixture was boiled using an electrothermal heater to completely dissolve the calcium carbonate. After cooled at normal temperature, the mixture was diluted to 100 mL using a volumetric flask and filtered. Thus, a measurement sample was produced.

Subsequently, this measurement sample was used to measure the alkali metal content (μmol/g) per 1 g of the surface-treated calcium carbonate with an atomic absorption measurement apparatus (polarized Zeeman atomic absorption spectrophotometer ZE3300, manufactured by Hitachi High-Tech Corporation). Then, the alkali metal content per unit specific surface area (μmol/m²) was calculated according to the formula (f1) below using the alkali metal content (μmol/g) and the BET specific surface area (Sw) obtained above.

$$Is = ( alkali metal content per 1 g of surface - treated calcium carbonate ( μmol / g ) ) / \{ Sw ( {m}^{2} / g ) \} \qquad ( f 1 )$$

### Example 1: Production of Surface-Treated Calcium Carbonate (E1)

Concentrated sulfuric acid was added to lime milk with a concentration of 5% at a temperature of 10° C. such that the amount thereof was 4.5% with respect to the mass of calcium hydroxide contained in the lime milk. Then, into the resulting mixture, mixed gas of CO₂ and air containing 20 vol % of CO₂ gas was introduced at a rate of 1700 L/hour per 1 kg of calcium hydroxide to produce a calcium carbonate slurry with a concentration of 6.8%. Subsequently, the calcium carbonate slurry was aged through stirring at a temperature of 30° C. to 35° C. for 30 hours. Then, a 10% aqueous solution of sodium beef tallow fatty acid (fatty acid-based surface treatment agent) (FA-T manufactured by Miyoshi Oil&Fat Co., Ltd., sodium-neutralized) obtained through thermal dissolution of the sodium beef tallow fatty acid in warm water was added to the calcium carbonate slurry such that the sodium beef tallow fatty acid solid was 14% of the calcium carbonate solid. The resulting mixture was stirred for 2 hours, and was then subjected to dehydration, drying, and powderization. Thus, calcium carbonate (E1) that had been subjected to surface treatment with the fatty acid-based surface treatment agent and had a BET specific surface area (Sw) of 45 m²/g was obtained. The physical property values of the obtained surface-treated calcium carbonate (E1) are shown in Table 1.

### Example 2: Production of Surface-Treated Calcium Carbonate (E2)

Calcium carbonate (E2) that had been subjected to surface treatment with the fatty acid-based surface treatment agent was produced in the same manner as in Example 1, except that the addition amount of the concentrated sulfuric acid was changed to 3.0% and the addition amount of the sodium beef tallow fatty acid was changed to 12%. The physical property values of the obtained surface-treated calcium carbonate (E2) are shown in Table 1.

### Example 3: Production of Surface-Treated Calcium Carbonate (E3)

Citric acid serving as a complex forming agent was added to lime milk with a concentration of 5% at a temperature of 10° C. such that the amount thereof was 2.0% with respect to the mass of calcium hydroxide. Then, into the resulting mixture, mixed gas of CO₂ and air containing 20 vol % of CO₂ gas was introduced at a flow rate of 1700 L/hour per 1 kg of calcium hydroxide to produce a calcium carbonate slurry with a concentration of 9.5%. Subsequently, the calcium carbonate slurry was aged through stirring at a temperature of 45° C. to 50° C. for 50 hours. Then, a 10% aqueous solution of sodium beef tallow fatty acid (fatty acid-based surface treatment agent) obtained through thermal dissolution of the sodium beef tallow fatty acid in warm water was added to the calcium carbonate slurry such that the sodium beef tallow fatty acid solid was 13% of the calcium carbonate solid. The resulting mixture was stirred for 24 hours to allow the surface treatment agent to sufficiently adsorb on the surface of the calcium carbonate, and was then subjected to dehydration, drying, and powderization. Thus, calcium carbonate (E3) that had been subjected to surface treatment with the fatty acid-based surface treatment agent and had a BET specific surface area (Sw) of 42 m²/g was obtained. The physical property values of the obtained surface-treated calcium carbonate (E3) are shown in Table 1.

### Example 4: Production of Surface-Treated Calcium Carbonate (E4)

Surface-treated calcium carbonate (E5) was produced in the same manner as in Example 1, except that Sodium Palm Fatty Acid (IPMD manufactured by Miyoshi Oil&Fat Co., Ltd., sodium-saponified) was used as a fatty acid-based surface treatment agent instead of the sodium beef tallow fatty acid. The physical property values of the obtained surface-treated calcium carbonate (E4) are shown in Table 1.

### Example 5: Production of Surface-Treated Calcium Carbonate (E5)

Surface-treated calcium carbonate (E5) was produced in the same manner as in Example 1, except that sodium oleate was used as a fatty acid-based surface treatment agent instead of the sodium beef tallow fatty acid. The physical property values of the obtained surface-treated calcium carbonate (E5) are shown in Table 1.

### Comparative Example 1: Production of Surface-Treated Calcium Carbonate (C1)

Citric acid serving as a complex forming agent was added to lime milk with a concentration of 8% at a temperature of 10° C. such that the amount thereof was 3.0% with respect to the mass of calcium hydroxide. Then, into the resulting mixture, mixed gas of CO₂ and air containing 20 vol % of CO₂ gas was introduced at a flow rate of 1700 L/hour per 1 kg of calcium hydroxide to produce a calcium carbonate slurry with a concentration of 10.8%. Subsequently, the calcium carbonate slurry was aged through stirring at a temperature of 45° C. to 50° C. for 50 hours. Then, a 10% aqueous solution of sodium beef tallow fatty acid (fatty acid-based surface treatment agent) obtained through thermal dissolution of the sodium beef tallow fatty acid in warm water was added to the calcium carbonate slurry such that the sodium beef tallow fatty acid solid was 13% of the calcium carbonate solid. The resulting mixture was stirred for 2 hours, and was then subjected to dehydration, drying, and powderization. Thus, calcium carbonate (C1) that had been subjected to surface treatment with the fatty acid-based surface treatment agent and had a BET specific surface area (Sw) of 48 m²/g was obtained. The physical property values of the obtained surface-treated calcium carbonate (C1) are shown in Table 1.

### Comparative Example 2: Production of Surface-Treated Calcium Carbonate (C2)

Calcium carbonate (C2) that had been subjected to surface treatment with the fatty acid-based surface treatment agent was obtained in the same manner as in Comparative Example 1, except that malic acid was used as a complex-forming agent instead of the citric acid. The physical property values of the obtained surface-treated calcium carbonate (C2) are shown in Table 1.

### Comparative Example 3: Production of Surface-Treated Calcium Carbonate (C3)

Mixed gas of CO₂ and air containing 20 vol % of CO₂ gas was introduced into the lime milk with a concentration of 5% at a temperature of 10° C. at a flow rate of 1700 L/hour per 1 kg of calcium hydroxide without adding a complex forming agent and an inorganic acid and/or a salt thereof to the lime milk. Thus, a calcium carbonate slurry with a concentration of 10.8% was produced. Subsequently, the calcium carbonate slurry was aged through stirring at a temperature of 30° C. to 35° C. for 30 hours. Then, a 10% aqueous solution of sodium beef tallow fatty acid (fatty acid-based surface treatment agent) obtained through thermal dissolution of the sodium beef tallow fatty acid in warm water was added to the calcium carbonate slurry such that the sodium beef tallow fatty acid solid was 5% of the calcium carbonate solid. The resulting mixture was stirred for 24 hours to allow the surface treatment agent to sufficiently adsorb on the surface of the calcium carbonate, and was then subjected to dehydration, drying, and powderization. Thus, calcium carbonate (C3) that had been subjected to surface treatment with the fatty acid-based surface treatment agent and had a BET specific surface area (Sw) of 17 m²/g was obtained. The physical property values of the obtained surface-treated calcium carbonate (C3) are shown in Table 1.

### Comparative Example 4: Production of Surface-Treated Calcium Carbonate (C4)

Calcium carbonate (C4) that had been subjected to surface treatment with the fatty acid-based surface treatment agent was obtained in the same manner as in Example 1, except that the addition amount of the sodium beef tallow fatty acid used as a fatty acid-based surface treatment agent was changed to 5%. The physical property values of the obtained surface-treated calcium carbonate (C4) are shown in Table 1.

### Comparative Example 5: Production of Surface-Treated Calcium Carbonate (C5)

Calcium carbonate (C5) that had been subjected to surface treatment with the fatty acid-based surface treatment agent was obtained in the same manner as in Example 1, except that a calcium carbonate slurry with a concentration of 16.28% was produced by changing the addition amount of the concentrated sulfuric acid used to 6.0% and changing the concentration of the lime milk to 12%, and this calcium carbonate slurry was aged. The physical property values of the obtained surface-treated calcium carbonate (C5) are shown in Table 1.

### Comparative Example 6: Production of Surface-Treated Calcium Carbonate (C6)

Calcium carbonate (C6) that had been subjected to surface treatment with the fatty acid-based surface treatment agent was obtained in the same manner as in Example 1, except that the addition amount of the sodium beef tallow fatty acid used as a fatty acid-based surface treatment agent was changed to 25%. The physical property values of the obtained surface-treated calcium carbonate (C6) are shown in Table 1.

### Comparative Example 7: Production of Surface-Treated Calcium Carbonate (C7)

Calcium carbonate (C7) that had been subjected to surface treatment with the fatty acid-based surface treatment agent was obtained in the same manner as in Example 4, except that the addition amount of the Sodium Palm Fatty Acid used as a fatty acid-based surface treatment agent was changed to 5%. The physical property values of the obtained surface-treated calcium carbonate (C7) are shown in Table 1.

### Comparative Example 8: Production of Surface-Treated Calcium Carbonate (C8)

Surface-treated calcium carbonate (C8) was obtained in the same manner as in Comparative Example 5, except that sodium oleate was used as a fatty acid-based surface treatment agent instead of the sodium beef tallow fatty acid. The physical property values of the obtained surface-treated calcium carbonate (C8) are shown in Table 1.

TABLE 1

| | | | | | | Comparative | Comparative |
|---|---|---|---|---|---|---|---|
| | Example 1 | Example 2 | Example 3 | Example 4 | Example 5 | Example 1 | Example 2 |
| Name of Surface-Treated Calcium | E1 | E2 | E3 | E4 | E5 | C1 | C2 |
| Carbonate Produced | | | | | | | |
| Sw (m²/g) | 45 | 38 | 42 | 46 | 45 | 48 | 48 |
| As (mg/m²) | 2.5 | 2.6 | 2.5 | 2.4 | 2.6 | 2.5 | 2.5 |
| LC (%) | 94 | 94 | 59 | 95 | 94 | 51 | 50 |
| Dxp (mm) | 0.011 | 0.013 | 0.017 | 0.012 | 0.011 | 0.016 | 0.014 |
| Dyp/Dxp | 97 | 83 | 60 | 90 | 99 | 86 | 94 |
| Is (mmol/m²) | 1.61 | 1.66 | 1.62 | 1.53 | 1.64 | 1.6 | 1.6 |
| (1)Lime Milk Conc.(%) | 5 | 5 | 7 | 5 | 5 | 8 | 8 |
| (2)Lime Milk Additive | Sulphric | Sulphric | Citric | Sulphric | Sulphric | Citric | Malic |
| | Acid | Acid | Acid | Acid | Acid | Acid | Acid |
| Conc. of Addtive | 4.5 | 3.0 | 2.0 | 4.5 | 4.5 | 3 | 3 |
| (3)Carbon Dioxide Gas Amount | 1700 | 1700 | 1700 | 1700 | 1700 | 1700 | 1700 |
| (4)Gas Conc. | 20 | 20 | 20 | 20 | 20 | 20 | 20 |
| (5)Calcium Carbonate Conc. | 6.8 | 6.8 | 9.5 | 6.8 | 6.8 | 10.8 | 10.8 |
| (6)Maturation Time | 30 | 30 | 50 | 30 | 30 | 50 | 50 |
| (7)Surface Treatment Amount | 14 | 12 | 13 | 14 | 14 | 15 | 15 |
| (8)Surface Treatment Time | 2 | 2 | 24 | 2 | 2 | 2 | 2 |
| (9)Surface Treatment Agent | Sodium | Sodium | Sodium | Sodium | Sodium | Sodium | Sodium |
| | Beef | Beef | Beef | Palm | Oleate | Beef | Beef |
| | Tallow | Tallow | Tallow | Fatty | | Tallow | Tallow |
| | Fatty | Fatty | Fatty | Acid | | Fatty | Fatty |
| | Acid | Acid | Acid | | | Acid | Acid |

| | Comparative | Comparative | Comparative | Comparative | Comparative | Comparative |
|---|---|---|---|---|---|---|
| | Example 3 | Example 4 | Example 5 | Example 6 | Example 7 | Example 8 |
| Name of Surface-Treated Calcium | C3 | C4 | C5 | C6 | C7 | C8 |
| Carbonate Produced | | | | | | |
| Sw (m²/g) | 17 | 49 | 40 | 41 | 51 | 39 |
| As (mg/m²) | 2.6 | 0.89 | 2.8 | 4.5 | 0.82 | 2.9 |
| LC (%) | 95 | 95 | 94 | 93 | 95 | 94 |
| Dxp (mm) | 0.039 | 0.045 | 0.012 | 0.010 | 0.047 | 0.011 |
| Dyp/Dxp | 33 | 26 | 42 | 53 | 25 | 41 |
| Is (mmol/m²) | 1.65 | 0.57 | 1.81 | 2.88 | 0.53 | 1.89 |
| (1)Lime Milk Conc.(%) | 5 | 5 | 12 | 5 | 5 | 12 |
| (2)Lime Milk Additive | None | Sulphric | Sulphric | Sulphric | Sulphric | Sulphric |
| | | Acid | Acid | Acid | Acid | Acid |
| Conc. of Addtive | — | 4.5 | 6.0 | 4.5 | 4.5 | 6.0 |
| (3)Carbon Dioxide Gas Amount | 1700 | 1700 | 1700 | 1700 | 1700 | 1700 |
| (4)Gas Conc. | 20 | 20 | 20 | 20 | 20 | 20 |
| (5)Calcium Carbonate Conc. | 6.8 | 6.8 | 16.2 | 6.8 | 6.8 | 16.2 |
| (6)Maturation Time | 30 | 30 | 50 | 30 | 30 | 50 |
| (7)Surface Treatment Amount | 5 | 5 | 14 | 25 | 5 | 14 |
| (8)Surface Treatment Time | 24 | 2 | 2 | 2 | 2 | 2 |
| (9)Surface Treatment Agent | Sodium | Sodium | Sodium | Sodium | Sodium | Sodium |
| | Beef | Beef | Beef | Beef | Palm | Oleate |
| | Tallow | Tallow | Tallow | Tallow | Fatty | |
| | Fatty | Fatty | Fatty | Fatty | Acid | |
| | Acid | Acid | Acid | Acid | | |

### Examples 6 to 10 and Comparative Examples 9 to 16: Production and Evaluation of Sealants

The surface-treated calcium carbonates (E1) to (E5) and (C1) to (C8) produced in Examples 1 to 5 and Comparative Examples 1 to 8 above were used to produce one component-type polyurethane-based sealants based on the composition below, and various properties thereof were evaluated. The results are shown in Table 2 and Table 3.

### Composition

Polyurethane resin Takenate L-1036 (manufactured by Mitsui Takeda Chemicals, Inc.) 430 parts
Heavy calcium carbonate (Super S, manufactured by Maruo Calcium Co., Ltd.) 230 parts
Surface-treated calcium carbonate produced in each of the examples and the comparative examples above 150 parts
Mineral turpentine 100 parts

### Kneading Method

The polyurethane resin was charged into a 5-L universal mixing-stirring machine (manufactured by Dalton Corporation), and the surface-treated calcium carbonate produced in each of the examples and the comparative examples above and the heavy calcium carbonate were dried at 105° C. for 2 hours or more in advance and were then simultaneously charged thereinto. Then, the resulting mixture was preliminarily stirred at a low speed for 15 minutes. Thereafter, the blend adhering to the inside of the mixing-stirring machine was scraped off and was immediately kneaded at a high speed for 30 minutes in a vacuum atmosphere. Finally, the mineral turpentine was charged and mixed at a low speed for 15 minutes in a vacuum atmosphere. A cartridge laminated with an aluminum foil was filled with the resulting mixture and was hermetically sealed using a metal plunger. Thus, a one component-type polyurethane sealant was produced.

### Viscosity Measurement Method

The above-mentioned sealant that had been allowed to stand at 23° C. for 1 day was filled into a 100-mL PP (polypropylene) cup using a cartridge gun, and the viscosities at 1 rpm and 10 rpm were measured using a TV-type viscometer (VISCOMETER TV-100BH, manufactured by Toki Sangyo) and were taken as initial viscosities of the sealant (range AH, spindle No. H7). In the case of 1 rpm, the value obtained after 3 minutes was taken as the viscosity value, and in the case of 10 rpm, the value obtained after 1 minute was taken as the viscosity value. A value obtained by dividing the viscosity value at 1 rpm by the viscosity value at 10 rpm was defined as a TI value.

After the cartridge filled with the sealant was allowed to stand at 50° C. for 7 days and was then allowed to cool at 23° C. for 3 hours, the viscosities were measured in the same manner as described above and were taken as the viscosity values and the TI value of the sealant after storage.

### Criteria for Sealant Viscosity

The viscosity was evaluated using the following criteria based on the TI value (1 rpm viscosity value/10 rpm viscosity value).
A: 6.0 or more
B: 5.5 or more and less than 6.0
C: 5.0 or more and less than 5.5
D: Less than 5.0

### Storage Stability Test

The viscosity change rates and the TI value change rate were calculated based on the formulae below using the initial viscosity values measured after the sealant was allowed to stand at 23° C. for 1 day and the viscosity values after storage measured after the sealant was allowed to stand at 50° C. for 7 days (and was then allowed to cool at 23° C. for 3 hours), and the storage stability (rate of change: %) was evaluated.

$$1 rpm viscosity change ratio = [ ( viscosity value at 1 rpm after storage ) \text{} / ( initial visosity value at 1 rpm ) ] \times 100 \qquad ( 1 )$$

$$10 rpm viscosity change ratio = [ ( viscosity value at 10 rpm after storage ) \text{} / ( initial visosity value at 10 rpm ) ] \times 100 \qquad ( 2 )$$

$$TI value change ratio = [ \text{} ( TI value after storage ) / ( initial TI value ) ] \times 100 \qquad ( 3 )$$

### Criteria for Storage Stability

The storage stability was evaluated using the following criteria based on the viscosity change ratios and the TI value change ratio.
A: The viscosity change ratios were less than 120% and the TI value change rate was 95% or more.
B: The viscosity change ratios were 120% or more and less than 140% and the TI value change rate was 90% or more and less than 95%.
C: The viscosity change ratios were 140% or more and less than 150% and the TI value change rate was 80% or more and less than 90%.
D: The viscosity change ratios were 150% or more and the TI value change rate was less than 80%.

### Tensile Test Method

After a primer was applied onto the surface of an aluminum plate (50 mm×50 mm×3 mm) and was dried for 60 minutes, the above-mentioned sealant was filled (into a shape with 12 mm×12 mm×50 mm) to produce an H-type specimen based on JIS A 1439 Sealing Material for Building 5.12.2 Durability, Production of Specimen.

After this specimen was cured at 23° C. for 14 days and then at 35° C. for 14 days, and was allowed to stand at 23° C. for 1 day, initial tensile test values were measured using a tensile tester (Autograph AG-1, manufactured by Shimadzu Corporation).

The evaluation items in Table 3 were as follows.
“50% Tensile Stress”: a value obtained by dividing a load when the specimen was drawn at a rate of 50 mm/minute and elongated until the elongation rate reaches 50% (6 mm) by the cross-sectional area of the sealant (600 mm²).
“Maximum Strength”: a value obtained by dividing the maximum load when the specimen was drawn at a rate of 50 mm/minute by the cross-sectional area of the sealant.
“Elongation Rate”: a value obtained by dividing the amount of displacement at the time of the measurement of the maximum strength by the shape (12 mm) at the time of filling and multiplying the obtained value by 100.
“Adhesiveness (initial)”: evaluated using the ratio of the adhesive area of the sealant remaining on the aluminum plate when the sealant was broken at the time of the tensile test performed after the sealant had been cured at 23° C. for 14 days and then at 35° C. for 14 days, and had been allowed to stand at 23° C. for 1 day.

### Criteria for Tensile Test

“50% Tensile Stress”
A: less than 0.20 N/mm².
B: 0.20 N/mm² or more.
“Maximum Strength”
A: 1.00 N/mm² or more.
B: 0.80 N/mm² or more and less than 1.00 N/mm².
C: 0.70 N/mm² or more and less than 0.80 N/mm².
D: less than 0.70 N/mm².
“Elongation Rate”
A: 800% or more.
B: 700% or more and less than 800%.
C: 600% or more and less than 700%.
D: less than 600%.
“Adhesiveness”

The state in which the sealant remained on the aluminum adhesive surface was represented by the ratio of cohesive failure (the ratio of the remaining adhesive area; CF %), and was evaluated using the following criteria.
A: The sealant was broken in a state in which 100% remained (CF100%).
B: The sealant was broken in a state in which 80% or more and less than 100% remained (CF50% to CF99%).
C: Less than 80% of the sealant remained (CF<80%) or the sealant peeled off (AF).
   Tensile Test Method after Heating

An H-type specimen was produced in the same manner as in the tensile test above. After being cured at 23° C. for 14 days and then 35° C. for 14 days, the specimen was subjected to high-temperature treatment at 100° C. for 14 days. After the specimen was allowed to cool at 23° C. for 1 day, the same tensile test was performed, and thus a tensile test values after heating were obtained.

### Thermal Stability Test

The change rates were calculated using the following formulae based on the initial tensile test values and the tensile test values after heating, and the thermal stability (rate of change: %) was evaluated.

$$50 \% tensile stress change ratio = [ \text{} ( 50 \% tensile stress after heating ) \text{} / ( initial 50 \% tensile stress ) ] \times 100 \qquad ( 1 )$$

$$Maximum strength change ratio \text{} \text{=:} [ \text{} ( maximum strength after heating ) / ( initial maximum strength ) ] \times 100 \qquad ( 2 )$$

$$Elongation change ratio = [ \text{} ( elongation rate after heating ) / ( initial elongation rate ) ] \times 100 \qquad ( 3 )$$

### Criteria for Thermal Stability

The thermal stability was evaluated using the following criteria based on the 50% tensile stress change ratio, the maximum strength change ratio and the elongation change ratio.
A: The 50% tensile stress change ratio and the maximum strength change ratio were less than 140%, and the elongation change ratio was 85% or more.
B: The 50% tensile stress change ratio and the maximum strength change ratio were 140% or more and less than 180%, and the elongation change ratio was 80% or more and less than 85%.
C: The 50% tensile stress change ratio and the maximum strength change ratio were 180% or more and less than 220%, and the elongation change ratio was 70% or more and less than 80%.
D: The 50% tensile stress change ratio and the maximum strength change ratio were 220% or more, and the elongation change ratio was less than 70%.

TABLE 2

| | Name of | | | | | | | | |
|---|---|---|---|---|---|---|---|---|---|
| | Surface- | | | | | | Storage Stability | | |
| | Treated | Sealant Viscosity | | | | | 1 rpm | 10 rpm | |
| | Calcium | | | | TI Value | | Viscosity | Viscosity | TI Value |
| | Carbonate | | 1 rpm | 10 rpm | (1 rpm/ | | Change | Change | Change |
| | Used | | (Pa · s) | (Pa · s) | 10 rpm) | Evaluaton | Ratio | Ratio | Ratio |
| Example 6 | E1 | Initial | 1250 | 210 | 6.0 | A | 117 | 126 | 93 |
| | | After Storage | 1460 | 265 | 5.5 | B | A | B | B |
| Example 7 | E2 | Initial | 1020 | 169 | 6.0 | A | 113 | 119 | 95 |
| | | After Storage | 1150 | 201 | 5.7 | B | A | A | A |
| Example 8 | E3 | Initial | 1000 | 172 | 5.8 | B | 137 | 148 | 92 |
| | | After Storage | 1370 | 255 | 5.4 | C | B | C | B |
| Example 9 | E4 | Initial | 1230 | 204 | 6.0 | A | 115 | 123 | 94 |
| | | After Storage | 1410 | 250 | 5.6 | B | A | B | B |
| Example 10 | E5 | Initial | 1250 | 206 | 6.1 | A | 116 | 125 | 93 |
| | | After Storage | 1450 | 258 | 5.6 | B | A | B | B |
| Comparative | C1 | Initial | 1310 | 221 | 5.9 | B | 143 | 182 | 78 |
| Examole 9 | | After Storage | 1870 | 402 | 4.7 | D | C | D | D |
| Comparative | C2 | Initial | 1340 | 218 | 6.1 | A | 141 | 178 | 79 |
| Examole 10 | | After Storage | 1890 | 388 | 4.9 | D | C | D | D |
| Comparative | C3 | Initial | 430 | 120 | 3.6 | D | 109 | 112 | 97 |
| Examole 11 | | After Storage | 468 | 134 | 3.5 | D | A | A | A |
| Comparative | C4 | Initial | 510 | 110 | 4.6 | D | 135 | 152 | 89 |
| Examole 12 | | After Storage | 688 | 167 | 4.1 | D | B | D | C |
| Comparative | C5 | Initial | 790 | 163 | 4.8 | D | 115 | 128 | 90 |
| Examole 13 | | After Storage | 910 | 209 | 4.4 | D | A | B | B |
| Comparative | C6 | Initial | 1540 | 310 | 5.0 | C | 168 | 193 | 87 |
| Examole 14 | | After Storage | 2590 | 598 | 4.3 | D | D | D | C |
| Comparative | C7 | Initial | 503 | 108 | 4.7 | D | 134 | 150 | 89 |
| Examole 15 | | After Storage | 675 | 162 | 4.2 | D | B | D | C |
| Comparative | C8 | Initial | 800 | 168 | 4.8 | D | 115 | 127 | 91 |
| Examole 16 | | After Storage | 920 | 213 | 4.3 | D | A | B | B |

TABLE 3

| | Name of | | | | | | | |
|---|---|---|---|---|---|---|---|---|
| | Surface- | Initial Tensile Test | | | | | | |
| | Treated | 50% | | | | | | |
| | Calcium | Tensile | | Maximun | | Elongation | | |
| | Carbonate | Stress | | Strength | | Rate | | |
| | Used | (N/mm²) | Evaluation | (N/mm²) | Evaluation | (%) | Evaluation | Adhesiveness |
| Example 6 | E1 | 0.14 | A | 1.06 | A | 840 | A | 100 |
| Example 7 | E2 | 0.14 | A | 1.18 | A | 770 | B | 100 |
| Example 8 | E3 | 0.15 | A | 1.00 | A | 780 | B | 100 |
| Example 9 | E4 | 0.13 | A | 1.07 | A | 880 | A | 100 |
| Example 10 | E5 | 0.13 | A | 1.07 | A | 850 | A | 100 |
| Comprative | C1 | 0.13 | A | 1.07 | A | 860 | A | 100 |
| Example 9 | | | | | | | | |
| Comparative | C2 | 0.13 | A | 1.07 | A | 880 | A | 100 |
| Example 10 | | | | | | | | |
| Comparative | C3 | 0.09 | A | 0.81 | B | 520 | D | 70 |
| Example 11 | | | | | | | | |
| Comparative | C4 | 0.45 | B | 0.63 | D | 390 | D | 60 |
| Example 12 | | | | | | | | |
| Comparative | C5 | 0.18 | A | 0.74 | C | 600 | C | 90 |
| Example 13 | | | | | | | | |
| Comparative | C6 | 0.10 | A | 0.78 | C | 670 | C | 100 |
| Example 14 | | | | | | | | |
| Comparative | C7 | 0.42 | B | 0.68 | D | 410 | D | 60 |
| Example 15 | | | | | | | | |
| Comparative | C8 | 0.17 | A | 0.76 | C | 620 | C | 90 |
| Example 16 | | | | | | | | |

| | | | | | Thermal Stability | | |
|---|---|---|---|---|---|---|---|
| | | Tensile Test After Heating | | | 50% | | |
| | Initial | 50% | | | Tebsile | Maximun | |
| | Tensile | Tensile | Maximun | Elongation | Stress | Strength | Elongation |
| | Test | Stress | Strength | Rate | Change | Change | Change |
| | Evaluation | (N/mm²) | (N/mm²) | (%) | Ratio | Ratio | Ratio |
| Example 6 | A | 0.24 | 1.44 | 700 | 171 | 136 | 83 |
| | | | | | B | A | B |
| Example 7 | A | 0.23 | 1.55 | 660 | 164 | 131 | 86 |
| | | | | | B | A | A |
| Example 8 | A | 0.28 | 1.48 | 620 | 187 | 148 | 79 |
| | | | | | C | B | C |
| Example 9 | A | 0.22 | 1.4 | 720 | 169 | 131 | 84 |
| | | | | | B | A | B |
| Example 10 | A | 0.23 | 1.45 | 700 | 177 | 136 | 82 |
| | | | | | B | A | B |
| Comprative | A | 0.33 | 2.12 | 500 | 254 | 198 | 58 |
| Example 9 | | | | | D | C | D |
| Comparative | A | 0.32 | 2.03 | 520 | 246 | 190 | 59 |
| Example 10 | | | | | D | C | D |
| Comparative | C | 0.13 | 1.03 | 400 | 144 | 127 | 77 |
| Example 11 | | | | | B | A | C |
| Comparative | C | 0.63 | 0.76 | 230 | 140 | 121 | 59 |
| Example 12 | | | | | B | A | D |
| Comparative | B | 0.33 | 1.08 | 510 | 183 | 146 | 85 |
| Example 13 | | | | | C | B | A |
| Comparative | A | 0.21 | 1.34 | 520 | 210 | 172 | 78 |
| Example 14 | | | | | C | B | C |
| Comparative | C | 0.59 | 0.8 | 250 | 140 | 118 | 61 |
| Example 15 | | | | | B | A | D |
| Comparative | B | 0.32 | 1.08 | 530 | 188 | 142 | 85 |
| Example 16 | | | | | C | B | A |

As shown in Table 2, it can be seen that all the sealants (Examples 6 to 10) in which the surface-treated calcium carbonates (E1) to (E5) produced in Examples 1 to 5 were used had a good initial sealant viscosity and a good sealant viscosity after storage and excellent storage stability, compared with the sealants (Comparative Examples 9 to 16) in which the surface-treated calcium carbonates (C1) to (C8) produced in Comparative Examples 1 to 8 were used.

Also, as shown in Table 3, it can be seen that all the sealants (Examples 6 to 10) in which the surface-treated calcium carbonates (E1) to (E5) produced in Examples 1 to 5 were used had a sufficient elongation rate even in the tensile test after heating and excellent thermal stability, compared with the sealants (Comparative Examples 9 to 16) in which the surface-treated calcium carbonates (C1) to (C8) produced in Comparative Examples 1 to 8 were used.

### Examples 11 to 15 and Comparative Examples 17 to 24: Production and Evaluation of Plastisols

The surface-treated calcium carbonates (E1) to (E5) and (C1) to (C8) produced in Examples 1 to 5 and Comparative Examples 1 to 8 above were used to produce plastisols (vinyl chloride paste sols) based on the composition below, and various properties thereof were evaluated. The results are shown in Table 4.

### Composition

Vinyl chloride paste resin PCH-843 (manufactured by Kaneka Corporation) 250 parts
Polyamide (manufactured by Henkel Japan Ltd.) 15 parts
Diisononyl phthalate (DINP) 250 parts
Quicklime (manufactured by FUJIFILM Wako Pure Chemical Corporation) 15 parts
Turpentine 37 parts
Surface-treated calcium carbonate produced in each of the examples and the comparative examples above 160 parts
Heavy calcium carbonate (Super S, manufactured by Maruo Calcium Co., Ltd.) 90 parts

### Kneading Method

Each blend was charged into a 5-L universal mixing-stirring machine (manufactured by Dalton Corporation) and kneaded for 3 minutes. The lid of the stirring machine was opened once, and the blend adhering to the wall surface was scraped off. Then, the blend was kneaded again for 10 minutes in a vacuum atmosphere. The kneaded sol was defoamed in a planetary defoaming kneader (KK-1000W, manufactured by Kurabo Industries Ltd.) under a kneading condition of May 5, 2018, and thus a vinyl chloride sol was produced. Note that, in the kneading condition “a-b-c” above, “a” represents a revolution condition, “b” represents a rotation condition, and “c” represents time (c×10 seconds).

### Viscosity Measurement

The kneaded plastisol was filled into a 100-mL PP (polypropylene) cup and was allowed to stand at 23° C. for 3 days. Then, the viscosities at 2 rpm and 20 rpm were measured as initial viscosities using a TV-type viscometer (VISCOMETER TV-100BH, manufactured by Toki Sangyo) (range AH, spindle No. H7).

In the case of the 2 rpm viscosity, the value obtained after 2 minutes was taken as the viscosity value, and in the case of 20 rpm, the value obtained after 1 minute was taken as the viscosity value. A value obtained by dividing the 2 rpm viscosity value by the 20 rpm viscosity value was used to represent the TI value. Furthermore, the kneaded plastisol filled into a 100-mL PP cup was allowed to stand at 40° C. for 3 days and was then allowed to cool at 23° C. for 3 hours. Then, the viscosities at 2 rpm and 20 rpm were measured as the viscosities after storage, and the numerical value of 2 rpm viscosity/20 rpm viscosity was measured as the TI value after storage.

### Criteria for Sol Viscosity

The viscosity was evaluated using the following criteria based on the TI value (2 rpm viscosity/20 rpm viscosity).
A: 6.00 or more.
B: 5.50 or more and less than 6.00.
C: 5.00 or more and less than 5.50.
D: less than 5.00.

### Storage Stability Test

The viscosity change rates and the TI value change rate were calculated based on the formulae below using the initial viscosity values measured after the sol was allowed to stand at 23° C. for 3 days and the viscosity values after storage measured after the sol was allowed to stand at 40° C. for 3 days (and was then allowed to cool at 23° C. for 3 hours), and the storage stability (rate of change: %) was evaluated.

$$Viscosity change rate = [ \text{} ( viscosity value at each rotation rate after storage ) \text{} / ( initial viscosity value at each rotation rate ) ] \times 100$$

$$TI value change rate = [ ( TI value after storage / initial TI value ) ] \times 100$$

### Criteria for Storage Stability

The storage stability was evaluated using the following criteria based on the viscosity change rates and the TI value change rate.
A: The viscosity change rates were less than 105% and the TI value change rate was 95% or more.
B: The viscosity change rates were 105% or more and less than 110% and the TI value change rate was 90% or more and less than 95%.
C: The viscosity change rates were 110% or more and less than 120% and the TI value change rate was 85% or more and less than 90%.
D: The viscosity change rates were 120% or more and the TI value change rate was less than 85%.

### Electrodeposition Plate Adhesion Test Method

The kneaded plastisol was applied onto a sufficiently polished steel plate with a size of 70 mm×150 mm such that the thickness of the plastisol was 3 mm. The plastisol was baked and cured for 30 minutes in an incubator at 100° C., and was exposed to normal temperature for 15 minutes and cooled. Then, the plastisol was allowed to stand at 130° C. for 30 minutes and was allowed to cool at normal temperature for 15 minutes. This operation was repeated twice. After being cooled, the cured coating was scraped with a nail, and the state in which the cured coating remained on the electrodeposition plate was represented by the ratio of cohesive failure (the ratio of the remaining adhesive area; CF %). The adhesion was thus confirmed, and was evaluated using the following criteria.

### Criteria for Electrodeposition Plate Adhesion

A: The cured coating had excellent adhesion, and when being scraped, the cured coating was broken (CF100%) in a state in which all the cured coating remained on the electrodeposition plate.
B: The cured coating had excellent adhesion, but when being scraped, the cured coating was broken (70%≤CF<100%) in a state in which 70% or more and less than 100% of the cured coating remained on the electrodeposition plate.
C: The cured coating easily peeled off, and when being scraped, the cured coating was broken (CF<70%) in a state in which only less than 70% of the cured coating remained on the electrodeposition plate.

TABLE 4

| | Name of | | | | | | | | | |
|---|---|---|---|---|---|---|---|---|---|---|
| | Surface- | | | | | | | | | |
| | Treated | Sol Viscosity | | | | | Storage Stability | | | |
| | Calcium | | | | TI Value | | 2 rpm | 20 rpm | TI | Electrodeposition |
| | Carbonate | | 2 rpm | 20 rpm | (2 rpm/ | | Change | Change | Change | Plate Adhesion |
| | Used | | (Pa · s) | (Pa · s) | 20 rpm) | Evaluation | Rate | Rate | Rate | (CF %) |
| Example 11 | E1 | Initial | 951 | 152.2 | 6.2 | A | 103 | 108 | 96 | 100 |
| | | After Storage | 978 | 163.7 | 6.0 | A | A | B | A | A |
| Example 12 | E2 | Initial | 875 | 138.5 | 6.3 | A | 101 | 103 | 99 | 100 |
| | | After Storage | 887 | 142.4 | 6.2 | A | A | A | A | A |
| Example 13 | E3 | Initial | 903 | 148.6 | 6.1 | A | 105 | 111 | 95 | 80 |
| | | After Storage | 946 | 164.3 | 5.8 | B | B | C | A | B |
| Example 14 | E4 | Initial | 985 | 157.6 | 6.3 | A | 101 | 105 | 97 | 100 |
| | | After Storage | 998 | 164.8 | 6.1 | A | A | B | A | A |
| Example 15 | E5 | Initial | 932 | 149.3 | 6.2 | A | 103 | 106 | 96 | 100 |
| | | After Storage | 956 | 158.8 | 6.0 | A | A | B | A | A |
| Comprative | C1 | Initial | 936 | 146.5 | 6.4 | A | 111 | 125 | 89 | 50 |
| Example 17 | | After Storage | 1040 | 182.8 | 5.7 | B | C | D | C | C |
| Comparative | C2 | Initial | 928 | 141.8 | 6.5 | A | 111 | 119 | 93 | 50 |
| Example 18 | | After Storage | 1030 | 169.4 | 6.1 | A | C | C | B | C |
| Comparative | C3 | Initial | 287 | 74.5 | 3.9 | D | 108 | 106 | 103 | 100 |
| Example 19 | | After Storage | 311 | 78.7 | 4.0 | D | B | B | A | A |
| Comparative | C4 | Initial | 336 | 87.3 | 3.8 | D | 103 | 106 | 97 | 100 |
| Example 20 | | After Storage | 346 | 92.6 | 3.7 | D | A | B | A | A |
| Comparative | C5 | Initial | 528 | 97.4 | 5.4 | C | 106 | 109 | 97 | 70 |
| Example 21 | | After Storage | 562 | 106.5 | 5.3 | C | B | B | A | B |
| Comparative | C6 | Initial | 648 | 113.1 | 5.7 | B | 113 | 120 | 95 | 50 |
| Example 22 | | After Storage | 735 | 135.6 | 5.4 | C | C | D | A | C |
| Comparative | C7 | Initial | 348 | 88.5 | 3.9 | D | 102 | 106 | 97 | 100 |
| Example 23 | | After Storage | 356 | 93.4 | 3.8 | D | A | B | A | A |
| Comparative | C8 | Initial | 521 | 95.7 | 5.4 | C | 105 | 107 | 98 | 80 |
| Example 24 | | After Storage | 548 | 102.2 | 5.4 | C | B | B | A | B |

As shown in Table 4, it can be seen that all the plastisols (Examples 11 to 15) in which the surface-treated calcium carbonates (E1) to (E5) produced in Examples 1 to 5 were used had a good initial sol viscosity and a good sol viscosity after storage, excellent storage stability, and excellent adhesion to the electrodeposition plate, compared with the plastisols (Comparative Examples 17 to 24) in which the surface-treated calcium carbonates (C1) to (C8) produced in Comparative Examples 1 to 8 were used.

### Examples 16 to 20 and Comparative Examples 25 to 32: Production and Evaluation of Paint Compositions

The surface-treated calcium carbonates (E1) to (E5) and (C1) to (C8) produced in Examples 1 to 5 and Comparative Examples 1 to 8 above were used to produce paint compositions based on the composition below, and various properties thereof were evaluated. The results are shown in Table 5.

### Composition

Mineral spirit 90 parts
Long-oil alkyd resin (oil length of 65%/NV70) 240 parts
Titanium oxide 140 parts
Surface-treated calcium carbonate produced in each of the examples and the comparative examples above 25 parts
Mixed dryer 5 parts
Anti-skinning agent 1 part
Glass beads 500 parts

### Preparation Method

The above-mentioned blend was dispersed using an SG mill to 10 μm or less on a grain gauge basis. Then, the glass beads were removed, and the resulting paint composition was placed in a paint can (200 mL). The paint can was hermetically sealed and was allowed to stand at 23° C. for 1 day. Thereafter, various physical properties were measured and evaluated according to the methods below.

### KU Value

The KU value of the paint composition in the paint can was measured using a krebs stormer viscometer (STOMER'S VISCOMETER, manufactured by Ueshima Seisakusho Co., Ltd.).

### Thixotropy

The viscosities of the paint composition in the paint can at 6 rpm and 60 rpm were measured using a TV-type viscometer (VISCOMETER TV-100BH, manufactured by Toki Sangyo) and were taken as initial viscosities (range AH, spindle No. H7). In both cases of 6 rpm and 60 rpm, the value obtained after 1 minute was taken as the viscosity value, and a value obtained by dividing the 6 rpm viscosity value by the 60 rpm viscosity value was defined as a TI value.

### Criteria for Thixotropy

The thixotropy was evaluated using the following criteria based on the obtained TI value (6 rpm viscosity value/60 rpm viscosity value).
A: 3.0 or more.
B: 2.5 or more and less than 3.0.
C: 2.0 or more and less than 2.5.
D: less than 2.0.

### Sagging Properties

The KU viscosity value of each paint composition was adjusted to 70 by adding mineral spirit, and then the paint composition was applied to all-black measurement paper using 250 μm, 200 μm, 150-μm, and 100-μm applicators. Immediately after the application, the paper was leaned against something such that the surface to which the paint composition had been applied extended in a vertical direction, and was allowed to stand at normal temperature for 24 hours. Then, the sagging state of the applied paint was evaluated using the following criteria.
A: Sagging of the paint was not observed.
B: Sagging of the paint was observed.

### Storage Stability of Paint Composition

The above-mentioned paint composition whose KU viscosity value was adjusted to 70 with mineral spirit was placed in a paint can (200 mL), and the paint can was hermetically sealed. After the paint can was stored in an oven at 50° C. for 4 weeks, a medicine spoon was used to softly scoop the paint composition on the bottom of the paint can, and it was visually confirmed whether or not a sediment accumulated.

### Criteria for Storage Stability

The storage stability of the paint composition that had been stored while being heated at 50° C. was evaluated using the following criteria.
A: No sediment was observed.
B: A sediment was observed.

TABLE 5

| | Name of | | | | | | | | | | |
|---|---|---|---|---|---|---|---|---|---|---|---|
| | Surface- | | | | | | | | | | |
| | Treated | | | | | | | | | | |
| | Calcium | | Thixotropy | | | | Sagging Properties | | | | |
| | Carbonate | KU | 6 rpm | 60 rpm | TI | | 250 | 200 | 150 | 100 | Storage |
| | Used | Value | (mPa · s) | (mPa · s) | Value | Evaluation | μm | μm | μm | μm | Stability |
| Example 16 | E1 | 83 | 5900 | 1680 | 3.5 | A | A | A | A | A | A |
| Example 17 | E2 | 80 | 4300 | 1430 | 3.0 | A | A | A | A | A | A |
| Example 18 | E3 | 81 | 5200 | 1600 | 3.3 | A | A | A | A | A | A |
| Example 19 | E4 | 84 | 6100 | 1690 | 3.6 | A | A | A | A | A | A |
| Example 20 | E5 | 82 | 5800 | 1700 | 3.4 | A | A | A | A | A | A |
| Comparative | C1 | 83 | 6400 | 1720 | 3.7 | A | A | A | A | A | B |
| Example 25 | | | | | | | | | | | |
| Comparative | C2 | 84 | 6500 | 1820 | 3.6 | A | A | A | A | A | B |
| Example 26 | | | | | | | | | | | |
| Comparative | C3 | 74 | 1250 | 640 | 2.0 | C | B | B | B | B | B |
| Example 27 | | | | | | | | | | | |
| Comparative | C4 | 76 | 1320 | 690 | 1.9 | D | B | B | B | B | B |
| Example 28 | | | | | | | | | | | |
| Comparative | C5 | 81 | 3600 | 1310 | 2.7 | B | B | B | A | A | A |
| Example 29 | | | | | | | | | | | |
| Comparative | C6 | 84 | 7300 | 1960 | 3.7 | A | A | A | A | A | A |
| Example 30 | | | | | | | | | | | |
| Comparative | C7 | 76 | 1540 | 810 | 1.9 | D | B | B | B | B | B |
| Example 31 | | | | | | | | | | | |
| Comparative | C8 | 80 | 3400 | 1360 | 2.5 | B | B | B | A | A | A |
| Example 32 | | | | | | | | | | | |

As shown in Table 5, it can be seen that all the paint compositions (Examples 16 to 20) in which the surface-treated calcium carbonates (E1) to (E5) produced in Examples 1 to 5 were used had favorable thixotropy, sagging properties, and storage stability, compared with the paint compositions (Comparative Examples 25 to 32) in which the surface-treated calcium carbonates (C1) to (C8) produced in Comparative Examples 1 to 8 were used.

### INDUSTRIAL APPLICABILITY

The present invention is useful in, for example, the resin molding field, the architectural/housing field, the paint field, and a wide range of technical fields related to these fields.

What is claimed is:

1. A surface-treated calcium carbonate comprising calcium carbonate subjected to surface treatment with a fatty acid-based surface treatment agent,
wherein the fatty acid-based surface treatment agent is at least one compound selected from the group consisting of fatty acids and fatty acid salts, and
relational expressions (a) to (f) below are satisfied:
$$20 \leq S w \underline{<} 100 ( {m}^{2} / g ) \qquad ( a )$$
$$1. \leq As \leq 7.5 ( mg / {m}^{2} ) \qquad ( b )$$
$$LC \geq 55 ( \% ) \qquad ( c )$$
$$0.003 \leq Dxp \leq 0.03 ( μm ) \qquad ( d )$$
$$50 \leq Dyp / Dxp \underline{<} 180 \qquad ( e )$$
$$0.03 \leq Is \leq 2.57 ( μmol / {m}^{2} ) . \qquad ( f )$$
where
Sw is a BET specific surface area (m²/g) that is determined through a nitrogen adsorption method,
As is loss on heat per unit surface area (mg/m²) that is determined using the following formula:
$$As = ( loss on heat per 1 g of the surface - treated calcium carbonate ( mg / g ) between 200 ° C . and 500 ° C . ) / Sw ( {m}^{2} / g ) ,$$
LC is a lightness maintenance ratio (%) that is determined using the following formula:
$$LC = ( an L value of a paste obtained by mixing the surface - treated calcium carbonate heated at 160 ° C . for 12 hours and diisononyl phthalate at a mass ratio of 1 to 2 ) \text{} / ( an L value of a paste obtained by mixing the calcium carbonate prior to heating and diisononyl - phthalate at a mass ratio of 1 to 2 ) \times 100 ,$$
Dxp is an average pore diameter (μm) at which an increase in a mercury intrusion amount (cumulative value of increases in pore volume/log (average pore diameter)) reaches a maximum value (Dyp) in a pore distribution within a pore range of 0.001 to 0.1 μm in a mercury intrusion method,
Dyp is the maximum value of an increase in the mercury intrusion amount (mL/g),
Dyp/Dxp is an average pore diameter amount, and
Is is an alkali metal content per unit specific surface area (μmol/m²) that is calculated using the following formula:
$$Is = ( an alkali metal content per 1 g of the surface - treated calcium carbonate ( μmol / g ) ) / \{ Sw ( {m}^{2} / g ) \} .$$

2. The surface-treated calcium carbonate according to claim 1, wherein the calcium carbonate subjected to surface treatment with a fatty acid-based surface treatment agent satisfies formulae (g) and (h) below:
$$0.005 \leq Dxp \leq 0.025 ( μm ) , and \qquad ( g )$$
$$60 \leq Dyp / Dxp \leq 150. \qquad ( h )$$

3. A resin composition comprising the surface-treated calcium carbonate according to claim 1; and a resin.

4. The resin composition according to claim 3, wherein the resin is a sealant resin.

5. The resin composition according to claim 3, wherein the resin is an adhesive resin.

6. The resin composition according to claim 3, wherein the resin is a paint resin.

7. The resin composition according to claim 3, wherein the resin is a plastisol resin.

8. A resin composition comprising the surface-treated calcium carbonate according to claim 2; and a resin.
